(19) United States
(12) Patent Application Publication
(10) Pub. No.: US 2010/0195892 A1
(43) Pub. Date: Aug. 5, 2010

(54) MEDICAL IMAGE DATA PROCESSING APPARATUS AND MEDICAL IMAGE DATA PROCESSING METHOD

(75) Inventors: Atsushi Sato, Shioya-gun (JP); Iwao Goto, Nasushiobara-shi (JP); Kenichi Niwa, Otawara-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-shi (JP)

(21) Appl. No.: 12/691,148

(22) Filed: Jan. 21, 2010

(30) Foreign Application Priority Data
Feb. 4, 2009 (JP) 2009-023847

(51) Int. Cl. G06K 9/00

(52) U.S. Cl. 382/132

(57) ABSTRACT

A medical image data processing apparatus includes: an imaging unit that has an X-ray tube for irradiating a subject with X-ray and an X-ray detector for detecting X-ray passed through the subject and scans the subject to collect raw data; a reconstruction unit that reconstructs image data from the collected raw data; a cutout unit that calculates, based on an image to be observed selected from the reconstructed image data, an imaging position of the image to be observed and cut outs, from the collected raw data, raw data existing within a previously set range including raw data constituting the image to be observed; and a storage unit that stores the raw data cut out by the cutout unit together with associated additional information.

### CROSS-REFERENCE TO RELATED APPLICATION

This application is based upon and claims the benefit of priority from the prior Japanese Patent Application No. 2009-23847, filed on Feb. 4, 2009, the entire contents of which are incorporated herein by reference.

### BACKGROUND OF THE INVENTION

1. Field of the Invention

The present invention relates to storage processing for storing CT raw data in a PACS (Picture Archiving and Communication System) or an X-ray CT apparatus and, more particularly, to a medical image data processing apparatus and a medical image data processing method that promote effective use of the raw data.

2. Description of the Related Art

At present, as a medical image diagnostic apparatus, an X-ray CT apparatus, an MRI apparatus, and the like are used. For example, an X-ray CT apparatus irradiates a subject with X-ray and detects the X-ray transmitted through the subject using an x-ray detector to thereby collect projection data and reconstructs a tomographic image of the subject using the collected projection data. Data which is obtained by applying predetermined preprocessing to the collected projection data is in the state immediately prior to reconstruction processing is referred to as “Raw data”. From the raw data, images under various conditions can be reconstructed.

Thus, the raw data is of high utility. Such row data is stored in a portable storage medium, separately from reconstructed image data. For a subsequent reconstruction request, the raw data stored in the storage medium is called for reconstruction. At this time, by changing reconstruction conditions (reconstruction function, reconstruction pitch, zoom, etc.), it is possible to obtain a new reconstructed image.

As the number of rows of an X-ray detector array is increased and scan speed thereof is increased, the size of the raw data generated by one imaging operation is growing every year and now reaches several GB (Giga-Byte) to several hundreds of GB. Thus, it becomes difficult to store the raw data in a portable storage device and, further, even in a hard disk of a server or the like, all the raw data cannot be stored.

Jpn. Pat. Appln. Laid-Open Publication No. 2008-100119 discloses a medical image diagnostic apparatus that stores a part of the raw data that has been cut out from the entire raw data. In this reference, a cutout range necessary among all of the collected raw data is designated and cut out, and the cut out part is written for storage into a storage device.

The stored raw data is eventually subjected to reconstruction, and an image-interpreting doctor performs image-viewing while observing reconstructed image to create a report. Recently, the image-interpreting doctor often uses a PACS or a report system for creating the image-viewing report. The creation of the image-viewing report becomes indispensable for image diagnosis using an X-ray CT apparatus or MRI apparatus that generates a large number of images.

The image-viewing report often includes a key image stored in association with the report, as well as a diagnosis. The key image is an image to be observed for diagnosis, and a doctor who utilizes the report reads an examination result report while referring to the key image to thereby easily grasp the diagnosis.

However, in the example of Jpn. Pat. Appln. Laid-Open Publication No. 2008-100119, the key image is not always stored in a storage medium, it is not necessarily possible for the doctor to refer to the key image and images around the key image. Further, it is not necessarily the case that image data reconstructed with doctor's desired parameters are stored.

### SUMMARY OF THE INVENTION

An object of the present invention is to provide a medical image data processing apparatus and a medical image data processing method that cuts out only raw data existing within a predetermined range based on the key image for storage in a storage unit.

According to a first aspect of the present invention, there is provided a medical image data processing apparatus comprising: an imaging unit that has an X-ray tube for irradiating a subject with X-ray and an X-ray detector for detecting X-ray passed through the subject and scans the subject to collect raw data; a reconstruction unit that reconstructs image data from the collected raw data; a cutout unit that calculates, based on an image to be observed selected from the reconstructed image data, an imaging position of the image to be observed and cut outs, from the collected raw data, raw data existing within a previously set range including raw data constituting the image to be observed; and a storage unit that stores the raw data cut out by the cutout unit together with associated additional information.

According to a second aspect of the present invention, there is provided a medical image data processing apparatus comprising: an input unit that receives as an input raw data obtained by detection of X-ray passed through a subject irradiated with X-ray from a plurality of directions and image data corresponding to a plurality of tomographic images obtained by reconstruction processing applied to the raw data; an extraction unit that extracts, based on an image to be observed selected from the plurality of tomographic images, raw data existing within a previously set range including raw data required for reconstructing image data corresponding to the image to be observed from the raw data input thereto from the input unit; and a storage unit that stores the extracted raw data together with associated additional information.

According to a third aspect of the present invention, there is provided a medical image data processing method that processes raw data collected by scanning a subject irradiated with X-ray and image data acquired by applying reconstruction processing to the collected raw data, comprising: selecting an image to be observed from the reconstructed image data; calculating the imaging position of the image to be observed based on additional information of the image to be observed; cutting out, from the collected raw data, raw data existing within a previously set range including raw data constituting the image to be observed; and storing the cutout raw data in the storage unit together with associated additional information.

### BRIEF DESCRIPTION OF THE DRAWINGS

FIG. 1 is a block diagram showing a configuration of an X-ray CT apparatus used in a medical image data processing apparatus according to an embodiment of the present invention;

FIG. 2 is a block diagram showing a configuration of a medical image storage apparatus used in the medical image data processing apparatus according to the embodiment of the present invention;

FIG. 3 is a view for explaining raw data storage processing according to the embodiment of the present invention;

FIG. 4 is a view for explaining a key image on a report screen in the present embodiment; and

FIG. 5 is a view for explaining raw data read out for half-reconstruction in the present embodiment.

### DESCRIPTION OF THE PREFERRED EMBODIMENTS

Throughout this description, the embodiments and examples shown should be considered as exemplars, rather than limitations on the apparatus of the present invention.

Hereinafter, an embodiment of the present invention will be described in detail with reference to the accompanying drawings. The same reference symbols are given to the same or corresponding elements in the drawings.

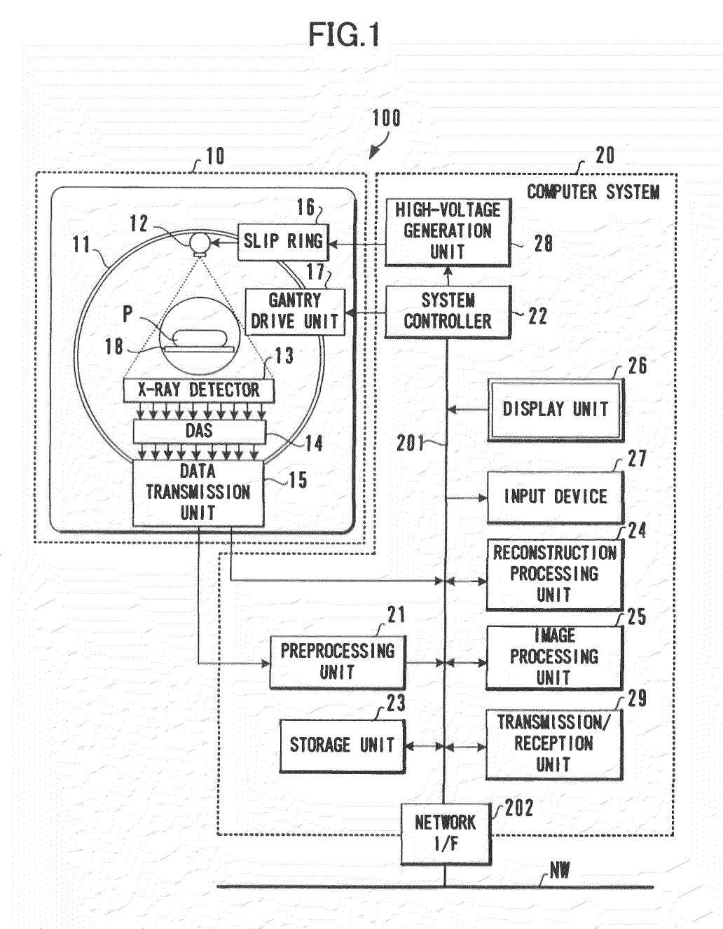

FIG. 1 is a configuration view of a medical image data processing apparatus according to an embodiment of the present invention. In the present embodiment, an X-ray CT apparatus (Computed Tomography Apparatus) is used as a medical image diagnostic apparatus used in a medical image data processing apparatus.

An X-ray CT apparatus 100 is constituted by a gantry 10 and a computer system 20. The gantry 10 collects projection data concerning a subject P and includes a rotating frame 11, an X-ray tube 12, an X-ray detector 13, a data collection unit 14, a non-contact type data transmission device 15, a slip ring 16, and a gantry drive unit 17.

The rotating frame 11 is a ring for rotational drive and carries the X-ray tube 12 and X-ray detector 13 thereon. An opening is formed in the center portion of the rotating frame 11, into which the subject P placed on a tabletop 18 of a bed (not shown) is inserted.

The X-ray tube 12 is a vacuum tube for generating X-ray. Power (tube current, tube voltage) required for X-ray irradiation is supplied to the X-ray tube 12 from a high-voltage generation unit 28 (to be described later) through the slip ring 16. The X-ray tube 12 causes electrons to accelerate and collide with a target using the supplied high-voltage to thereby irradiate the subject P placed within an effective field of view with X-ray.

The X-ray detector 13 detects X-ray passed through the subject P and is attached to the rotating frame 11 at a portion facing the X-ray tube 12. The X-ray detector 13 is, e.g., a multislice detector in which a plurality of detection elements formed by combining scintillators and photodiodes are two-dimensionally arranged. The X-ray tube 12 and X-ray detector 13 constitute an imaging unit.

The data collection unit 14, which is called a DAS (Data Acquisition System), converts a signal output from the X-ray detector 13 for each channel into a voltage signal, amplifies the voltage signal, and converts the amplified voltage signal into a digital signal. The obtained digital signal data is sent to the computer system 20 through the non-contact type data transmission device 15.

The gantry drive unit 17 rotationally drives the rotating frame 11. With the rotation of the rotating frame 11, the X-ray tube 12 and X-ray detector 13 are rotated while facing each other substantially about the body axis of the subject P. When the tabletop 18 is moved along the body axis of the subject P simultaneously with the rotation, so-called “helical scan” in which the subject P is helically scanned is enabled.

The computer system 20 includes a preprocessing unit 21, a system controller 22, a storage unit 23, a reconstruction processing unit 24, an image processing unit 25, a display unit 26, an input device 27, a high-voltage generation unit 28, and a transmission/reception unit 29. Further, the computer system 20 includes a bus line 201 and a network interface 202.

The preprocessing unit 21 receives raw data from the data collection unit 14 through the non-contact type data transmission device 15 and applies sensitivity correction or X-ray intensity correction to the raw data. The system controller 22 is connected to the bus line 201 and performs overall control of the X-ray CT apparatus 100. Concretely, the system controller 22 performs scan processing, signal processing, image generation processing, image display processing, and the like.

The raw data that has been subjected to various corrections by the preprocessing unit 21 is called “projection data”, which is temporarily stored in the storage unit 23 through the bus line 201. The reconstruction processing unit 24 is provided with a plurality of types of reconstruction methods and uses a reconstruction method selected by an operator to reconstruct image data.

The image processing unit 25 applies image processing for display, such as window conversion and RGB processing, to the reconstructed image data generated by the reconstruction processing unit 24 and outputs the resultant image data to the display unit 26. Further, based on an instruction from an operator, the image processing unit 25 generates a tomographic image having a given cross-unit, a projection image in a given direction, a three-dimensional image, and the like and outputs them to the display unit 26. The storage unit 23 stores image data such as reconstructed tomographic image data in addition to the raw data.

The display unit 26 displays a CT image such as a computer tomography image input from the image processing unit 25. The input device 27 is provided with a keyboard, various switches, a mouse, and the like, through which an operator inputs e.g., various scan conditions such as slice thickness or number of slices. The high voltage generation unit 28 supplies power required for X-ray irradiation to the X-ray tube 12 though the slip ring 16.

The transmission/reception unit 29 communicates with other devices such as an RIS (Radiology Information System) server, a PACS, and the like (not shown) through a network NW and receives information (patient information, order information including a site to be diagnosed) concerning imaging of the subject P from, e.g., the RIS server connected to the network NW. Further, the transmission/reception unit 29 transmits image data, patient information, and the like to the PACS through the network NW.

Further, in the scan processing, the system controller 22 controls the high-voltage generation unit 28, gantry drive unit 17, feed amount and feed speed of the tabletop 18 in the body axis direction, rotational speed, rotational pitch, X-ray irradiation timing of the X-ray tube 12 and X-ray detector 13, and the like based on the input scan conditions such as slice thickness. This allows a desired imaging area of the subject to be irradiated with X-ray cone beam or X-ray fan beam from a plurality of directions for X-ray CT image data collection (scan) processing. Examples of scan operation include a conventional scan of one rotation, a helical scan, and the like.

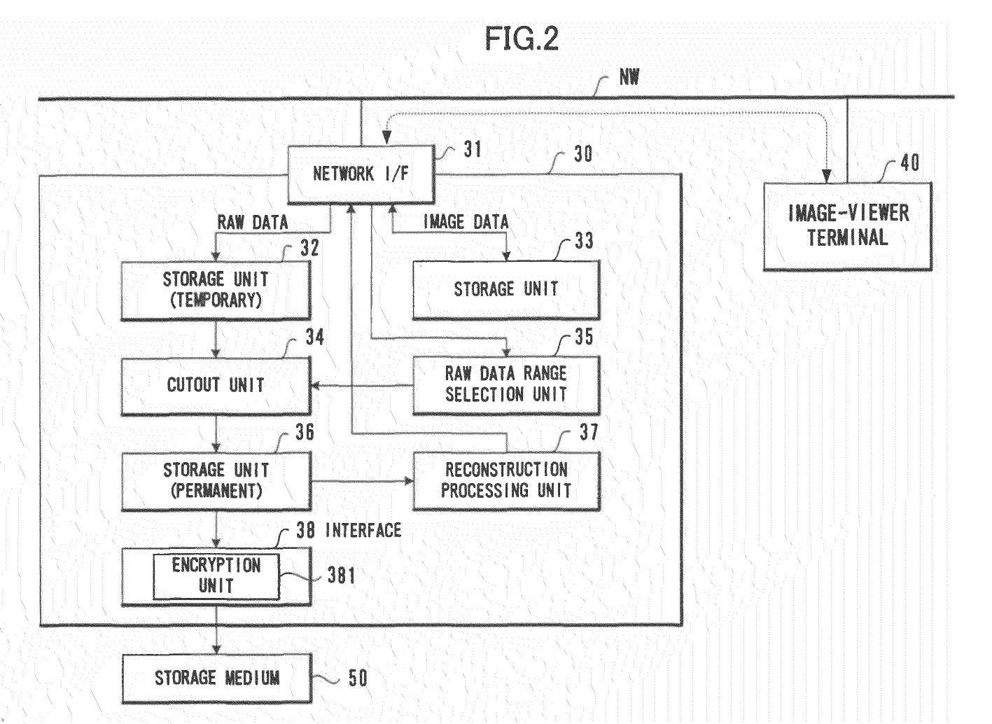

FIG. 2 is a block diagram showing a medical image storage apparatus 30 used in the medical image data processing apparatus according to the embodiment of the present invention. The medical image storage apparatus 30 is connected to the network NW and receives the raw data and reconstructed image data from the medical image diagnostic apparatus (X-ray CT apparatus 100) through a network interface 31. An image-viewer terminal 40 is also connected to the network NW, and information can be exchanged between the medical image storage apparatus 30 and image-viewer terminal 40 through the network NW.

The medical image storage apparatus 30 includes storage units 32 and 33, a cutout unit 34, a raw data range selection unit 35, a storage unit 36, a reconstruction processing unit 37, and an interface 38. The storage unit 32 temporarily stores received raw data, and storage unit 33 stores received image data.

The network interface 31 corresponds to an input unit that inputs image data corresponding to raw data and a plurality of tomographic images obtained by applying reconstruction processing to the raw data.

Image data stored in the storage unit 33 is sent to the image-viewer terminal 40 so that a doctor can refer to it for image-viewing. The doctor refers to reconstructed images and, if there is any image to be observed, sets the image as an image to be observed (key image: to be described later).

After the setting of the image to be observed, additional information of the key image is sent to the raw data range selection unit 35 from the image-viewer terminal 40. The raw data range selection unit 35 selects the cutout range of the raw data based on the image to be observed of the reconstructed image data. The raw data range selection unit 35 selects, e.g., the abovementioned key image as the image to be observed and sends the additional information of the key image to the cutout unit 34. The cutout unit 34 cuts out raw data constituting the key image from raw data temporarily stored in the storage unit 32 based on the additional information of the key image.

The cutout unit 34 corresponds to an extraction unit that extracts raw data within a previously set range from raw data input through the interface 38.

The raw data (cutout raw data) stored in the storage unit 36 is supplied to the reconstruction processing unit 37. The reconstruction processing unit 37 performs reconstruction processing in response to a request from the image-viewer terminal 40 and displays the reconstructed image on the image-viewer terminal 40. The cutout raw data stored in the storage unit 36 can be stored in a storage medium 50 through the interface 38. The interface 38 includes an encryption unit 381, and the storage medium 50 is, e.g., a portable storage medium.

In the image-viewer terminal 40, a doctor writes down a diagnosis as a report, as well as, specifies a key image (image to be observed for diagnosis) and adds it to the created report. Further, recently, there is available a hyperlink report system in which the key image is added to the corresponding sentence in the report in the form of a hyperlink.

A doctor performs image-viewing of an examination result while referring to a key image associated with a report on a previous result. The key image is a useful image for diagnosis. That is, in the case where the same patient undergoes a CT examination once again, a previously photographed key image and a key image that has newly been photographed in the same position and under the same conditions as the previous are compared to each other, whereby a change in a disease state can be grasped in detail.

In the embodiment of the present invention, imaging position information or imaging elapsed time information is extracted from the additional information of the key image marked by the image-viewing, the imaging position of the image to be observed (key image) is calculated based on the extracted information, and raw data constituting the image to be observed and raw data therearound are cut out and stored together with the additional information attached thereto.

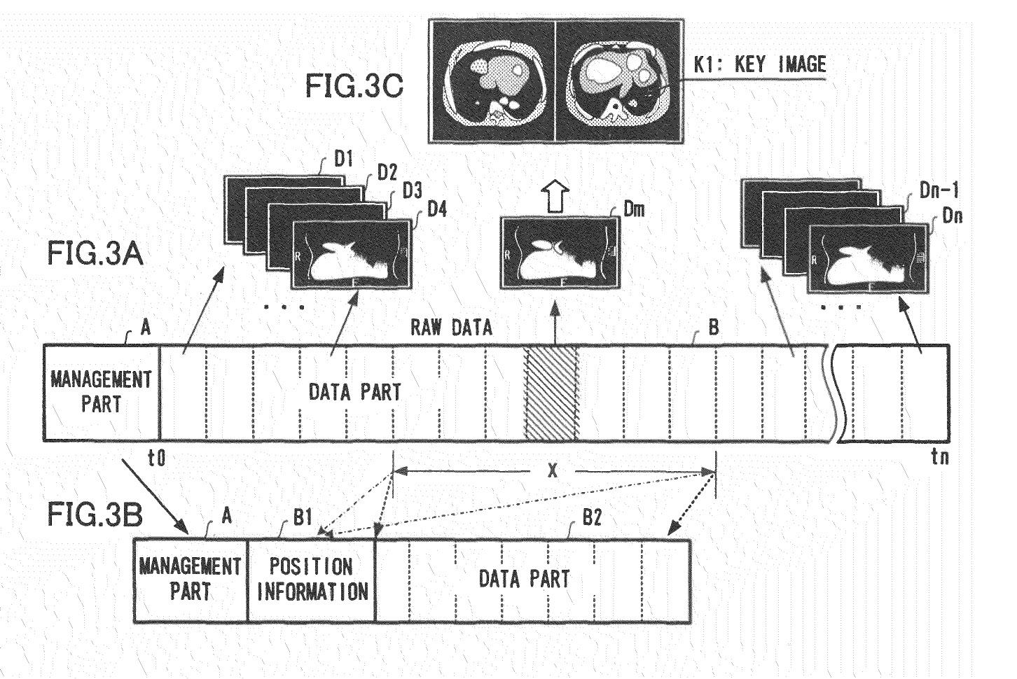

Next, with reference to FIG. 3, operation of storing the raw data and reconstructed image data acquired in the X-ray CT apparatus 100 in the medical image storage apparatus 30 will be described.

FIG. 3A shows raw data temporarily stored in the storage unit 32, which corresponds to raw data transferred from the X-ray CT apparatus 100. The storage unit 32 has a storage capacity capable of storing all acquired raw data. FIG. 3B shows cutout raw data cut out by the cutout unit 34 and permanently stored in the storage unit 36. FIG. 3C shows a key image in the image-viewer terminal 40.

As shown in FIG. 3A, the raw data is composed of a management part A and a data part B. The management part A includes patient information such as patient name, patient ID, etc., information concerning imaging conditions (imaging site, imaging direction, imaging position, imaging range, etc.) under which imaging is performed, and information concerning image conditions (slice thickness, slice pitch, etc.).

The data part B is composed of temporally-consecutive raw data D1, D2, . . . , Dn which are obtained from imaging start time t0 to imaging end time tn. Dm denotes raw data constituting a key image. The data part B further includes, as the additional information, imaging position information obtained when the raw data is scanned. The imaging position information includes, e.g., elapsed time information representing elapsed time from the start of the scan and distance information which is based on the position at which the scan is started.

FIG. 3C shows an example of a key image K1 attached to a report screen created by a doctor on the image-viewer terminal 40. The doctor creates a report by performing image-viewing of the reconstructed image data stored in the storage unit 33 and sets this key image K1 as an image to be observed for diagnosis. Alternatively, the key image K1 may be associated with the sentence in the report in the form of a hyperlink. The key image K1 includes the imaging position information as the additional information.

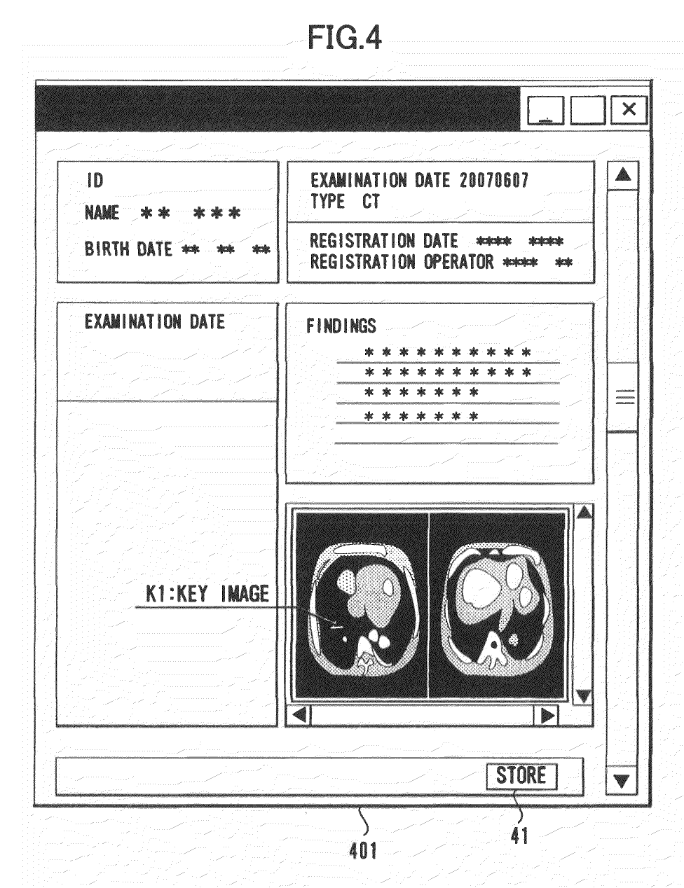

FIG. 4 is a view showing an example of a report screen 401 displayed on the image-viewer terminal 40. The report screen 401 includes a field to which the key image K1 is attached in addition to a patient name field, a findings field, and the like. Further, a store key 41 is displayed on the report screen 401. To store information on the report screen 401 including the key image K1, the store key 41 is clicked using a mouse, whereby the information is stored in the storage unit 33 of the medical image storage apparatus 30.

The raw data range selection unit 35 selects the cutout range of the raw data based on the image to be observed (key image) set by the image-viewer terminal 40 and notifies the cutout unit 34 of the cutout range. The cutout unit 34 calculates the imaging position of the key image K1 based on the additional information of the key image K1 and then cuts out the raw data constituting the key image K1 and raw data therearound.

More specifically, the cutout unit 34 cuts out raw data existing within a predetermined range (range indicated by an arrow x) by which the key image K1 and images around the key image K1 can be reconstructed with raw data Dm constituting the key image K1 set as a center and stores the cutout raw data in the storage unit 36 together with associated additional information. The original raw data is deleted from the storage unit 36 at the time point when the cut out is completed.

The cutout raw data stored in the storage unit 36 is, as shown in FIG. 3B, composed of the management part A, position information B1, and data part B2. Additional information (e.g., patient information, information concerning imaging conditions under which imaging is performed, information concerning image conditions, etc.) of the cutout raw data is stored in the management part A. Position information of the cutout raw data is stored in the position information area B1.

For example, as the position information of the cutout raw data, time information concerning the raw data from the start to end of the scan is counted and, based on the counted time information, raw data constituting a previously set number of images including the key image K1 and images therearound is stored. The data part area B2 is composed of the raw data cut out by the cutout unit 34, which corresponds to raw data existing within the cutout range x where the raw data Dm is defined as a center.

As the image to be observed used in the raw data range selection unit 35, an image to which KIN (Key Image Note) or other mark information has been attached may be selected in place of the key image K1. That is, when a given image is determined as an important image by a doctor at the time of the image-viewing, a mark or the like is attached to the image, so that by reading out the mark information, it is possible to select the image to be observed.

As described above, in the present invention, with reference to the key image, it is possible to store raw data constituting a predetermined number of images including the key image and images around the key image in the storage unit 36 together with the associated additional information. The cutout raw data stored in the storage unit 36 is, so to speak, the best selected data, and since only raw data important for diagnosis is stored in the storage unit 36, the storage capacity can be saved.

The reconstruction processing unit 37 uses the raw data stored in the storage unit 36 to perform reconstruction processing. The reconstruction processing unit 37 can use the same parameters as those used in generation of the key image K1 to perform the reconstruction processing or can use different parameters to perform the reconstruction processing for the raw data associated with the key image K1 and images around the key image K1.

Thus, it is possible to compare an image to be interpreted reconstructed based on the cot-out raw data and an image to be interpreted used for the selection of the image to be observed (key image K1). Further, if previous cutout raw data for the same patient is stored in the storage unit 36, a comparison can be made between the previous and current images for image-viewing.

Further, the cutout raw data stored in the storage unit 36 can be stored in the storage medium 50. It is sufficient for the storage medium 50 to have a storage capacity capable of storing the cutout raw data, thus requiring less storage capacity, which allows the cutout raw data stored in the storage unit 36 to be stored in the portable storage medium 50. In the case where the cutout raw data is stored in the portable storage medium 50, the data is preferably encrypted in the encryption unit 381 in order to prevent leakage of confidential information so that only a user who knows a decryption key can decrypt the data.

When a reconstruction request is subsequently made in this case, the cutout raw data stored in the storage medium 50 is called for reconstruction. At this time, by changing reconstruction conditions (reconstruction function, reconstruction pitch, zoom, etc.), it is possible to obtain a new reconstructed image data.

In the above description, the cutout range of the raw data is specified by the number of images including the key image K1 and images around the key image K1. Alternatively, however, a configuration may be employed in which the number of seconds (time) from the start of the scan to end thereof is counted and raw data existing within a predetermined time range where the raw data Dm is defined as a center is cut out. Another configuration may further be employed in which a distance from a position at which the scan is started to the scan end position is counted and raw data existing within a predetermined distance range where the raw data Dm is defined as a center is cut out.

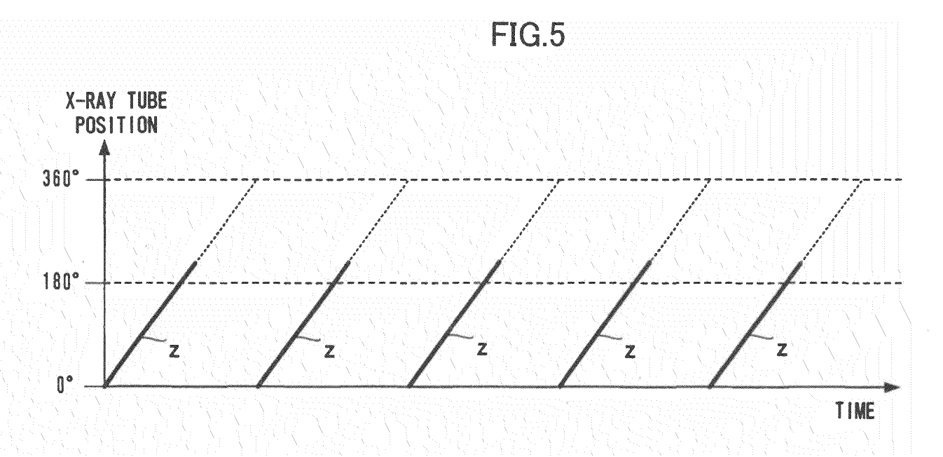

FIG. 5 is a view for explaining counting operation of counting the number of seconds (time) from the start of the scan of the raw data to end thereof. FIG. 5 shows an example in which a half-reconstruction method is adopted for the raw data reconstruction processing to reconstruct image data based on projection data (raw data) corresponding to (180°+fan angle) around the subject. For convenience of explanation, the projection data corresponding to (180°+fan angle) is regarded as one unit and referred to as a projection data set.

In FIG. 5, the vertical axis denotes the position (angular position) of the X-ray tube 12, and horizontal axis denotes time. Further, the angular range within which a plurality of projection data sets are read out according to the position of the X-ray tube 12 is denoted by a bold line Z. In this example, the projection data set covers a range within which the X-ray tube is rotated from a view angle)(0°) to view angle (180°+α), and a plurality of projection data sets z are used for the half-reconstruction.

Thus, when the number of elapsed seconds from the start of the scan is counted, time information corresponding to the raw data part (bold line Z) needs to be stored. Further, the size (detection range of the X-ray detector) of the raw data obtained by one scan changes depending on the size (number of detection elements or resolution power) of the X-ray detector 13, so that the time information needs to be calculated with the size of the X-ray detector 13 taken into consideration.

Further, the cutout unit 34 may set the raw data cutout range in accordance with a site to be examined. Further, the cutout unit 34 may set the raw data cutout range in accordance with the size of an affected site.

According to the embodiment of the present invention described above, the raw data cutout range is set based on the key image and only the raw data corresponding to an important part for diagnosis is stored in the storage unit 36, whereby the storage capacity of the storage unit 36 can be saved. Further, it is possible to save the cutout raw data in a portable storage medium, enabling effective use of the raw data.

Further, it is possible to use raw data around the raw data constituting the key image to perform reconstruction processing with various parameters and display reconstructed image data for comparative image-viewing between a previous image and newly obtained image, thereby improving the quality of image-viewing.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A medical image data processing apparatus comprising:
an imaging unit that has an X-ray tube for irradiating a subject with X-ray and an X-ray detector for detecting X-ray passed through the subject and scans the subject to collect raw data;
a reconstruction unit that reconstructs image data from the collected raw data;
a cutout unit that calculates, based on an image to be observed selected from the reconstructed image data, an imaging position of the image to be observed and cut outs, from the collected raw data, raw data existing within a previously set range including raw data constituting the image to be observed; and
a storage unit that stores the raw data cut out by the cutout unit together with associated additional information.

2. The medical image data processing apparatus according to claim 1, wherein
a key image associated with an image-viewing report created using the reconstructed image data is selected as the image to be observed, and
the cutout unit calculates the imaging position of the key image based on the additional information of the key image and cuts out, from the collected raw data, raw data existing within a previously set range with the raw data constituting the key image as a center.

3. The medical image data processing apparatus according to claim 1, wherein
the cutout unit calculates the imaging position of the image to be observed based on imaging time information or imaging position information included in the additional information of the key image.

4. The medical image data processing apparatus according to claim 1, wherein
the cutout unit specifies the raw data cutout range by the previously set number of images including the image to be observed.

5. The medical image data processing apparatus according to claim 1, wherein
the cutout unit specifies the raw data cutout range by time or distance with the raw data constituting the image to be observed as a center.

6. The medical image data processing apparatus according to claim 1, wherein
the cutout unit sets the raw data cutout range in accordance with a site to be examined.

7. The medical image data processing apparatus according to claim 1, further comprising an interface for storing the raw data cut out by the cutout unit in a portable storage medium together with associated additional information.

8. The medical image data processing apparatus according to claim 1, further comprising a second reconstruction processing unit that reconstructs image data from the raw data cut out by the cutout unit.

9. An image data processing apparatus comprising:
an input unit that receives as an input raw data obtained by detection of X-ray passed through a subject irradiated with X-ray from a plurality of directions and image data corresponding to a plurality of tomographic images obtained by reconstruction processing applied to the raw data;
an extraction unit that extracts, based on an image to be observed selected from the plurality of tomographic images, raw data existing within a previously set range including raw data required for reconstructing image data corresponding to the image to be observed from the raw data input thereto from the input unit; and
a storage unit that stores the extracted raw data together with associated additional information.

10. A medical image data processing method that processes raw data collected by scanning a subject irradiated with X-ray and image data acquired by applying reconstruction processing to the collected raw data, comprising:
selecting an image to be observed from the reconstructed image data;
calculating the imaging position of the image to be observed based on additional information of the image to be observed;
cutting out, from the collected raw data, raw data existing within a previously set range including raw data constituting the image to be observed; and
storing the cutout raw data together with associated additional information.

11. The medical image data processing method according to claim 10, wherein
a key image associated with an image-viewing report created using the reconstructed image data is selected as the image to be observed,
the imaging position of the key image is calculated based on the additional information of the key image, and
raw data existing within a previously set range is cut out from the collected raw data with the raw data constituting the key image as a center.

12. The medical image data processing method according to claim 10, wherein
the imaging position of the image to be observed is calculated based on imaging time information or imaging position information included in the additional information of the key image.

13. The medical image data processing method according to claim 10, wherein
the raw data cutout range is specified by the previously set number of images including the image to be observed.

14. The medical image data processing method according to claim 10, wherein
the raw data cutout range is specified by time or distance with the raw data constituting the image to be observed as a center.

15. The medical image data processing method according to claim 10, wherein
the raw data cutout range is set in accordance with a site to be examined.

16. The medical image data processing method according to claim 10, wherein
the cutout raw data is stored in a portable storage medium together with associated additional information.

17. The medical image data processing method according to claim 10, wherein
image data is reconstructed from the cutout raw data.
